(19) United States
(12) Patent Application Publication
(10) Pub. No.: US 2015/0317105 A1
(43) Pub. Date: Nov. 5, 2015

(54) INFORMATION PROCESSING APPARATUS AND METHOD FOR CONTROLLING THE SAME

(71) Applicant: CANON KABUSHIKI KAISHA, Tokyo (JP)

(72) Inventor: Hidekazu Morooka, Kawasaki-shi (JP)

(21) Appl. No.: 14/699,050

(22) Filed: Apr. 29, 2015

(30) Foreign Application Priority Data
May 1, 2014 (JP) 2014-094792

(51) Int. Cl. G06F 3/12

(52) U.S. Cl. CPC G06F 3/1217; G06F 3/1206; G06F 3/1296

(57) ABSTRACT

The number of jobs in a printing apparatus is obtained at a timing that is associated with a timing at which the printing apparatus is polled; a transmission control value associated with the number of jobs that are to remain in the printing apparatus is calculated, in a case in which the obtained number of jobs is not equal to a predetermined value; and jobs according to a number of jobs determined from the calculated transmission control value are transmitted to the printing apparatus.

### BACKGROUND OF THE INVENTION

1. Field of the Invention

The present invention relates to a technique for processing a print job for printing.

2. Description of the Related Art

These days, in the commercial printing field in which offset printing has been employed, the offset printing is being replaced by another printing method for increasing the efficiency at a printing site and showing an improvement in the functionality, such as an increased printing speed, of an electrophotographic printing apparatus (printer). In the commercial printing field, a large number of jobs may be transmitted to a printer. It is known, however, that when a large number of jobs are transmitted to a printer at once, some of the jobs that the printer is unable to accept may be lost or printing performance may be reduced as the number of jobs to be managed by the printer becomes too large.

According to a technique discussed in Japanese Patent Application Laid-Open No. 2010-128989, information is obtained periodically from a printer (polling), and when the number of jobs that have been transmitted to the printer reaches or exceeds a predetermined threshold value, transmission of a print job is paused, and thus a decrease in the printing performance of the printer is suppressed.

However, the technique discussed in Japanese Patent Application Laid-Open No. 2010-128989 has shortcomings in that when a transmitted job is finished while the printer is being polled, the printer enters a printing stand-by state.

### SUMMARY OF THE INVENTION

The present invention is directed to providing a technique that can reduce an occurrence of an instance in which a printer enters a printing stand-by state.

According to an aspect of the present invention, an information processing apparatus includes an obtaining unit configured to obtain the number of jobs in a printing apparatus at a timing that is associated with a timing at which the printing apparatus is polled, a calculation unit configured to calculate a transmission control value associated with the number of jobs that are to remain in the printing apparatus in a case in which the obtained number of jobs is not equal to a predetermined value, and a transmission unit configured to transmit jobs according to a number of jobs determined from the calculated transmission control value, to the printing apparatus.

Further features of the present invention will become apparent from the following description of exemplary embodiments with reference to the attached drawings.

### BRIEF DESCRIPTION OF THE DRAWINGS

FIG. 1 is a system configuration diagram of an information processing system according to an exemplary embodiment of the present invention.

FIG. 2 is a block diagram illustrating a configuration of an information processing apparatus.

FIG. 3 illustrates an example of a memory map of a random-access memory (RAM).

FIG. 4 is a functional block diagram of an information processing system according to an exemplary embodiment of the present invention.

FIG. 5A illustrates a change in the number of jobs in a printer when an existing method is applied, and FIG. 5B illustrates an example of a change in the number of jobs in a printer when a first exemplary embodiment is applied.

FIG. 6 is a flowchart illustrating transmission control processing according to the first exemplary embodiment.

FIG. 7 is a flowchart illustrating one of the steps according to the first exemplary embodiment in detail.

FIGS. 8A and 8B illustrate examples of the change in the number of jobs in a printer when second and third exemplary embodiments, respectively, are applied.

FIG. 9 is a flowchart illustrating initial value calculation processing according to the second exemplary embodiment.

FIG. 10 illustrates an example of a user interface.

FIG. 11 is a flowchart illustrating one of the steps according to the third exemplary embodiment in detail.

### DESCRIPTION OF THE EMBODIMENTS

Hereinafter, exemplary embodiments of the present invention will be described in detail with reference to the drawings. It is to be noted that the exemplary embodiments described hereinafter are merely illustrative and are not intended to limit the scope of the present invention.

First, terms used in the first exemplary embodiment will be described.

### <Polling Processing>

In polling processing, information is obtained from a printing apparatus (printer) at regular intervals. For example, in 10-second polling, information is obtained from a printer at intervals of 10 seconds. When the polling interval is reduced, the number of instances the printer carries out processing corresponding to the polling processing increases, and the printing performance thus decreases. Therefore, it is desirable that the polling interval be set to be as long as possible.

### <Printer Stand-by State>

In a printer stand-by state, the number of jobs which remain in the printer and of which printing has not been performed is 0, and print processing of the printer is being paused. During this period, printing is not carried out. Thus, in order to increase the productivity, it is desirable to reduce the duration of the printer stand-by state, while the polling interval is set not too short.

### <Transmission Control Value>

A transmission control value used in the present exemplary embodiment will be described. When the polling processing is carried out on a printer and job information of the printer is obtained, the number of jobs in the printer is controlled to a predetermined number of jobs (threshold value). This is for reducing or suppressing an occurrence of the printer stand-by state. Thus, a target value of the number of jobs to remain in the printer when a job is transmitted to the printer after the polling processing is defined as the transmission control value in the present exemplary embodiment.

A specific example of the transmission control value will be described. When the initial transmission control value is set to 10 and the number of jobs in the printer obtained at a polling timing is 2, the number of jobs to be processed in a polling interval is 8. When the threshold value is 5, the subsequent transmission control value is set to 13 (8+5=13) so that the number of jobs in the printer at a subsequent polling timing becomes 5 (the threshold value). In the present exemplary embodiment, the transmission control value corresponds to a target value of the number of jobs remaining in the printer at a polling timing (the number of jobs remaining in a queue in the printer).

The number of jobs to be transmitted at a timing immediately after the polling processing is obtained through Expression (1).

the number of jobs to be transmitted at a timing immediately after the polling processing=transmission control value−the number of jobs obtained at a polling timing (1)

When the transmission control value is 13 and the number of jobs in the printer obtained at a polling timing is 2, 11 jobs are to be transmitted to the printer after the polling processing.

### <Printer Queue Full>

In a queue full state, the number of received jobs exceeds the upper limit of the buffer number of the printer for receiving jobs. The jobs of which printing has not been performed by the printer can be determined by obtaining the number of jobs remaining in the queue (the number of jobs remaining in the printer) in the present exemplary embodiment, but a different method may instead be employed. A job that is transmitted while the printer is in the queue full state cannot be accepted by the printer. In addition, when the queue full state occurs, a resource, such as a free memory space, in the printer is reduced, which may lead to a problem that the printing performance decreases. The size of the printer queue depends on the performance of a memory or a central processing unit (CPU) installed in the printer.

Hereinafter, exemplary embodiments of the present invention will be described with reference to the drawings.

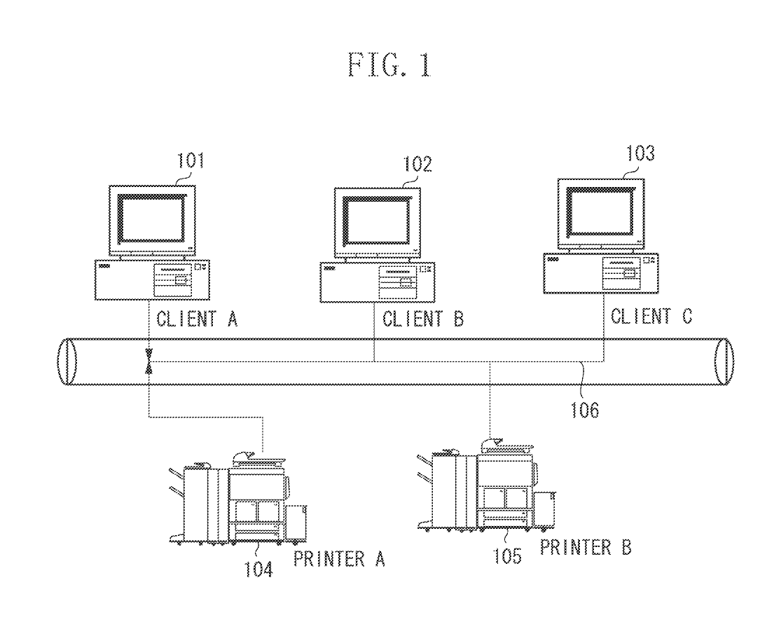

FIG. 1 illustrates an overall configuration of an information processing system according to an exemplary embodiment of the present invention. It is to be noted that the environment of the information processing system as a whole in the following description is employed for facilitating the understanding of the description of the present invention, but the present invention is not limited to such an environment.

Referring to FIG. 1, network computers (hereinafter, referred to as the information processing apparatuses) 101, 102, and 103 are connected to a network 106 and can communicate with one another. The information processing apparatuses 101, 102, and 103, which typically are personal computers, are connected to the network 106 through a network cable and can execute various types of programs, such as an application program.

The information processing apparatuses 101, 102, and 103 are provided with functions of transferring print job data (hereinafter, referred to as job data) generated in the respective information processing apparatuses 101, 102, and 103, to network printers (hereinafter, referred to as printers) 104 and 105. In addition, the information processing apparatuses 101, 102, and 103 can obtain information on the job data that the printers 104 and 105 have received and have processed or stored therein through the network 106, and can display and edit the obtained information.

The printers 104 and 105 are printing apparatuses. The printers 104 and 105 are connected to the network 106 through network interfaces (not illustrated). The printers 104 and 105 analyze the job data that includes print data transmitted from the information processing apparatuses 101, 102, and 103 so as to convert the job data to a dot image on a page-by-page basis and then print the dot image.

In addition, the printers 104 and 105 display the job data received from the information processing apparatuses 101, 102, and 103 on user interfaces of the respective printers 104 and 105, transmit emails to the information processing apparatuses 101, 102, and 103, and transmit a FAX to a facsimile device (not illustrated).

Hereinafter, when the printers 104 and 105 need to be distinguished from each other, the printers 104 and 105 are referred to as a printer A and a printer B, respectively. It is to be noted that the printers 104 and 105 may differ from each other in terms of their functionality.

In addition, the network 106 is connected to the information processing apparatuses 101, 102, and 103, the printers 104 and 105, and so on.

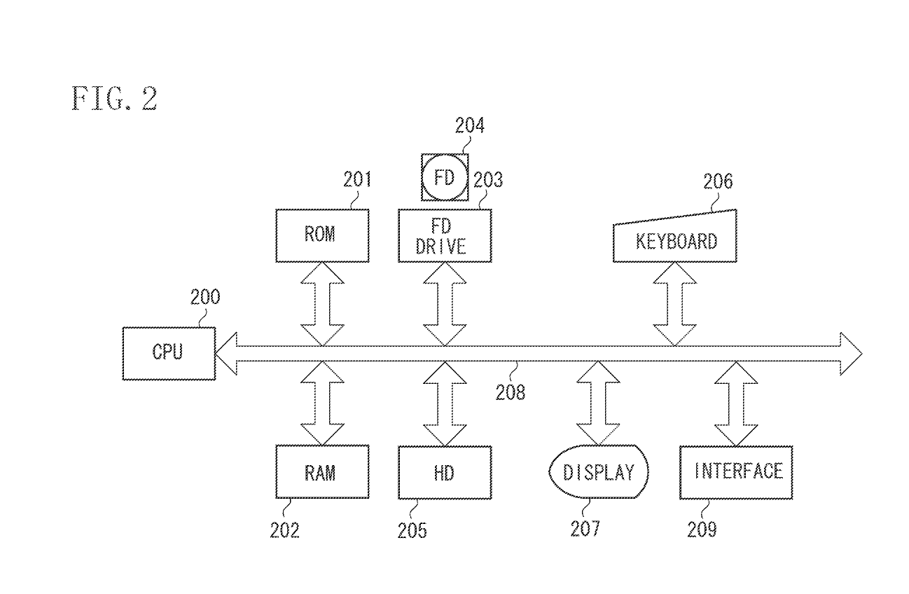

FIG. 2 is a block diagram for describing the configuration of the information processing apparatus 101. The configurations of the information processing apparatuses 102 and 103 are similar to the configuration of the information processing apparatus 101. Referring to FIG. 2, a CPU 200 controls the information processing apparatus 101 as a whole. The CPU 200 executes an application program, a printer driver program, an operating system (OS), an information processing program according to the present exemplary embodiment, and so on that are stored in a hard disk (HD) 205. In addition, the CPU 200 carries out control for temporarily storing information, files, and so on that are necessary for executing the programs into a random-access memory (RAM) 202.

A read-only memory (ROM) 201 serves as a storage unit and stores therein programs, such as a basic I/O program, various pieces of data, such as font data to be used when processing a document and data for a template. The RAM 202 serves as a temporary storage unit and functions as a main memory, a work area, and so on for the CPU 200.

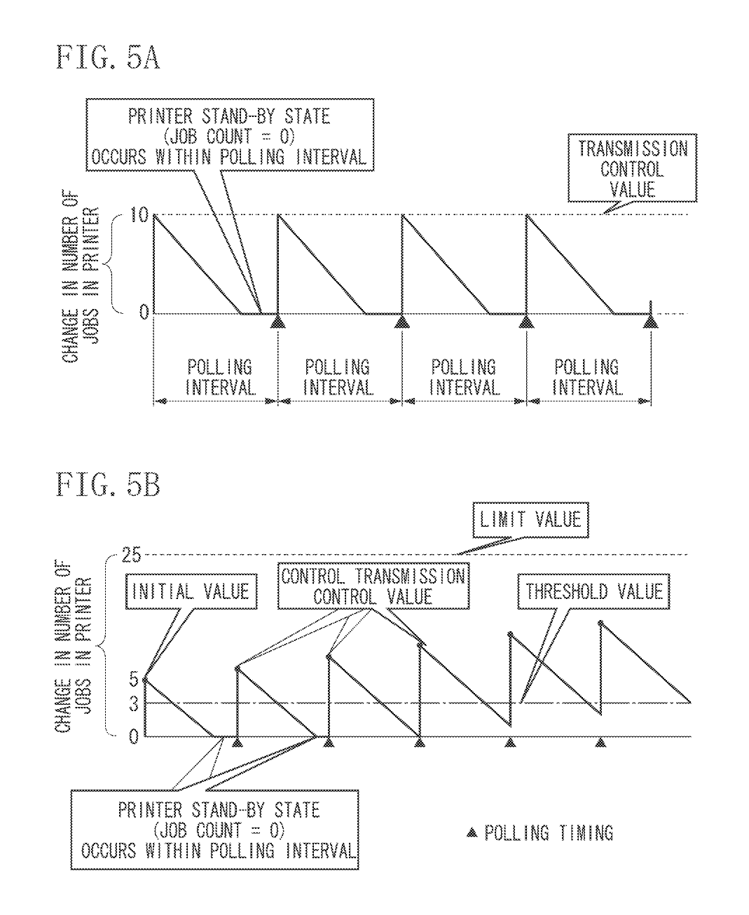

A flexible disk (FD) drive 203 serves as a storage medium reading unit, and a program and so on stored in an FD 204 serving as a storage medium can be loaded onto the information processing apparatus 101 through the FD drive 203, as illustrated in FIG. 5. The FD 204 is a storage medium and stores programs that the information processing apparatus 101 can read. The storage medium is not limited to an FD and can be any storage medium, such as a compact disc read-only memory (CD-ROM), a compact disc recordable (CD-R), a compact disc rewritable (CD-RW), a personal computer (PC) card, a digital versatile disc (DVD), an integrated circuit (IC) memory card, a magneto optical disc (MO), and a memory stick.

The HD 205 serves as an external storage unit and functions as a large-capacity memory. The HD 205 stores an application program, a printer driver program, an OS, an information processing program, an associated program, and so on.

A keyboard 206 serves as an instruction input unit and allows a user to input an instruction, such as a command for controlling a device, into the information processing apparatus 101. A display 207 serves as a display unit and displays a command that is input through the keyboard 206, a printer status, and so on.

A system bus 208 controls a flow of data in the information processing apparatus 101.

An interface 209 serves as an input and output port from and to an external apparatus, and the information processing apparatus 101 exchanges data with an external apparatus through the interface 209.

The configuration of the information processing apparatus 101 described above is an example and is not limited to the exemplary configuration illustrated in FIG. 2. For example, the storage destination of the data or the programs can be changed among the ROM 201, the RAM 202, the HD 205, and so on in accordance with the characteristics of the data or the programs.

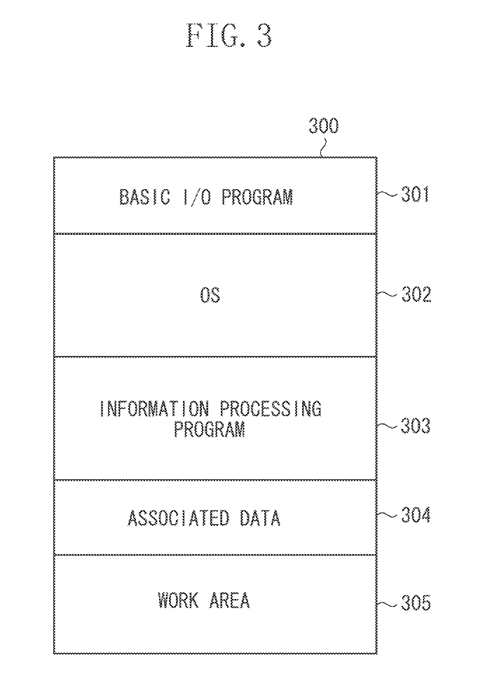

FIG. 3 illustrates an example of a memory map of the RAM 202 illustrated in FIG. 2 and illustrates a memory map in a state in which the information processing program, loaded from the FD 204, for controlling the information processing system according to an exemplary embodiment of the present invention has been loaded onto the RAM 202 and can be executed.

An example in which the information processing program and the associated data are directly loaded from the FD 204 onto the RAM 202 and are executed will be described in the present exemplary embodiment. Aside from such an example, however, each time the information processing program is put in operation, the information processing program may be loaded onto the RAM 202 from the HD 205 in which the information processing program has been installed from the FD 204.

A basic I/O program 301 is provided with an initial program loading (IPL) function in which, upon the power supply of the information processing apparatus 101 being turned on, the OS is loaded from the HD 205 onto the RAM 202 and the operation of the OS is started. OS 302 and information processing program 303 are stored in an area secured in the RAM 202. Associated data 304 is stored in an area secured in the RAM 202. A work area 305 is an area secured for the CPU 200 to execute the information processing program 303.

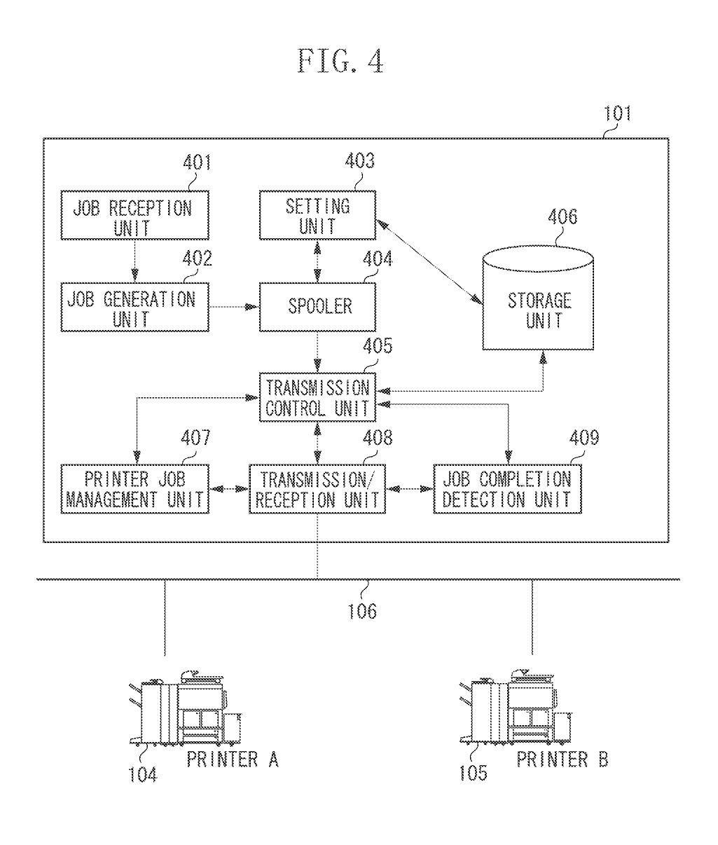

FIG. 4 is a functional block diagram of the information processing apparatus 101 in the information processing system.

A job reception unit 401 receives print data and output setting information from an application. A job generation unit 402 generates job data that can be processed by an output destination printer from the print data and the output setting information received by the job reception unit 401. A setting unit 403 for transmission control data obtains an initial value of data necessary for controlling transmission through a user interface or from a configuration file stored in a storage unit 406.

A spooler 404 temporarily spools job data received from the job generation unit 402 and successively outputs the job data to a transmission control unit 405. The transmission control unit 405 adjusts the number of jobs to be transmitted. The storage unit 406 stores system information, such as information set by the setting unit 403 and the number of jobs to be transmitted determined by the transmission control unit 405.

A transmission/reception unit 408 transmits job data to the printers 104 and 105 through the network 106 or receives information from the printers 104 and 105. Job information of a printer may be obtained by requesting the information from the printer at predetermined intervals (polling processing) or by receiving event notifications periodically from the printer. A printer job information management unit 407 is a print job management unit that reads out the number of jobs stored in the printer (the number of queued jobs) from the printer information obtained by the transmission/reception unit 408.

A job completion detection unit 409 reads out a time at which a job subjected to printing has been completed, from the printer information obtained by the transmission/reception unit 408. This processing is valid only when the data obtained from the printer includes a job completion time. For example, the above processing is valid when the printer transmits a notification through ReturnQueueEntry in Java Media Framework (JMF) as status information of the printer with respect to a job subjected to printing through the job definition format (JDF) and the data includes the completion time.

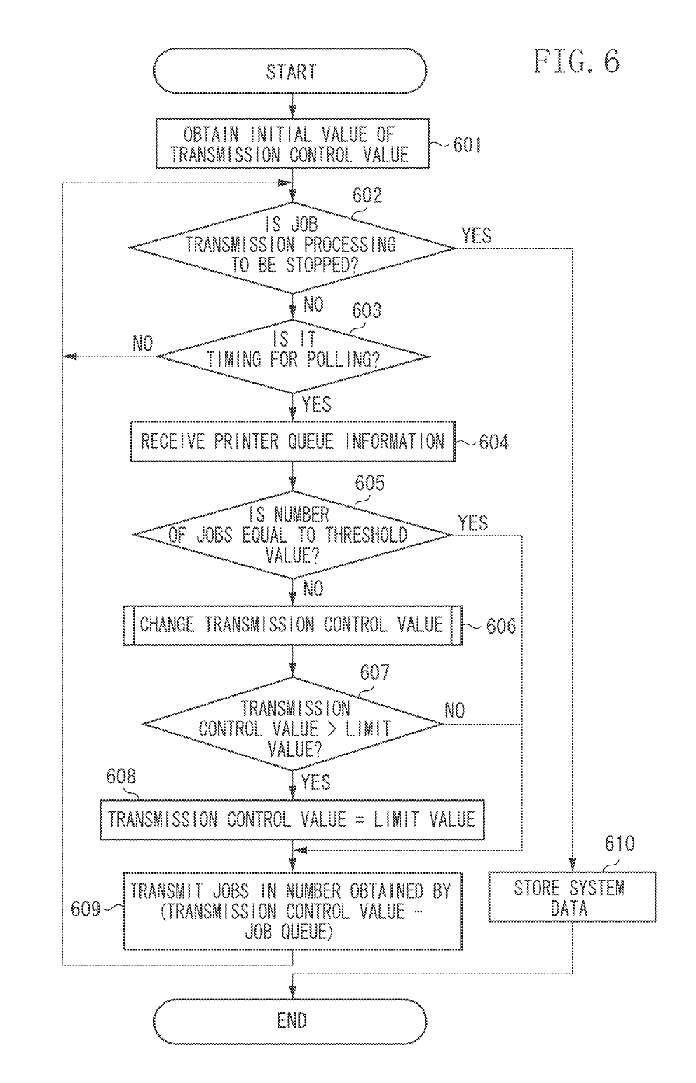

FIG. 6 is a flowchart illustrating processing of controlling data transmission from the information processing apparatus 101, 102, or 103 to the printer 104 or 105. Programs for the respective processes are stored in the HD 205 of the information processing apparatus 101, 102, or 103, and the programs are loaded onto the RAM 202 and executed by the CPU 200. An example in which job transmission from the information processing apparatus 101 to the printer A (printer 104) illustrated in FIG. 1 is controlled will be described in following sequence.

In step S601, the setting unit 403 obtains an initial value of the transmission control value from the storage unit 406. Examples of the initial value of the transmission control value include the number of jobs that can be displayed on a printer panel and the number of jobs that includes a margin so that the buffer (queue) of the printer A does not become full (e.g., a value corresponding to 30% of the value at which the queue full state occurs). In step S602, the transmission control unit 405 determines whether job transmission processing is to be stopped. When the printing is to be terminated or when a print application system is shut down (YES in step S602), a flag for print termination is raised and the processing is terminated in accordance with the instruction. Then, the processing proceeds to step S610. When the determination result indicates otherwise (NO in step S602), the processing proceeds to step S603. In step S603, the transmission control unit 405 determines whether it is a timing for the transmission/reception unit 408 to obtain printer information (timing for polling). Although the printer A is polled whereby information is obtained at specific intervals in the present exemplary embodiment, event notifications may be received periodically from the printer A, and the job data information may be obtained accordingly.

When the transmission control unit 405 determines in step S603 that it is a timing for polling (YES in step S603), in step S604, the transmission/reception unit 408 receives printer queue information as the printer information. The printer queue information includes information on the number of jobs remaining in the queue in the printer A (the number of jobs remaining in the printer). In step S605, the transmission control unit 405 obtains the number of jobs remaining in the queue in the printer A (the number of jobs remaining in the printer) from the printer queue information, and determines whether the obtained number of jobs is equal to a predetermined threshold value. When it is determined that the obtained number of jobs is equal to the threshold value (YES in step S605), the processing proceeds to step S609. When it is determined otherwise (NO in step S605), the processing proceeds to step S606.

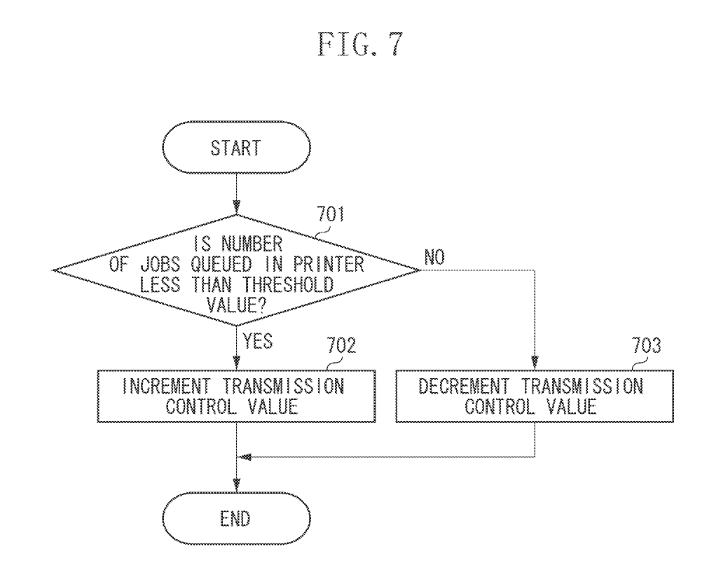

In step S606, the transmission control unit 405 changes the transmission control value. FIG. 7 is a detailed flowchart of step S606.

In step S701, the transmission control unit 405 determines whether the number of jobs remaining in the printer A is less than the threshold value. When the number of jobs remaining in the printer A is less than the threshold value (YES in step S701), in step S702, the transmission control unit 405 increments the transmission control value by 1. Meanwhile, when the number of jobs remaining in the printer is not less than the threshold value (NO in step S701), in step S703, the transmission control unit 405 decrements the transmission control value by 1.

In step S607, the transmission control unit 405 determines whether the transmission control value that has been changed in step S606 exceeds a limit value (the number of jobs at which a queue full state occurs). When it is determined in this step that the aforementioned value exceeds the limit value (YES in step S607), the processing proceeds to step S608. In step S608, the transmission control value that has been changed in step S606 is replaced by the limit value.

In step S609, the transmission/reception unit 408 transmits jobs to the printer A in a number obtained by subtracting the number of jobs remaining in the printer A from the transmission control value. By the steps described above having been carried out, when it is determined in step S602 that the processing is to be terminated, the processing proceeds to step S610, and in step S610, system data, such as the transmission control value and the polling intervals, is stored into the storage unit 406 so that the system data can be used in a subsequent instance of reprinting.

The transmission control value stored in step S610 may serve as the initial value of the transmission control value in the subsequent instance of printing.

FIGS. 5A and 5B are illustrations for describing the effect of the present exemplary embodiment. FIG. 5A is a graph illustrating a change in the number of jobs in a printer when the present exemplary embodiment is not applied but an existing method is applied. The vertical axis of the graph illustrated in FIG. 5A indicates the number of jobs in the printer, and the horizontal axis indicates the time. The polling intervals are regular polling intervals at which the printer is polled. The polygonal line illustrated in FIG. 5A represents the change in the number of jobs in the printer of which printing has not been performed. In this example, the transmission control value is set to 5. After five jobs are transmitted to the printer, the printer finishes printing of all of the transmitted jobs in a polling interval and enters a state in which the number of jobs in the printer is 0 (printer stand-by state) until the subsequent polling timing since the timing at which the printer has finished printing of the jobs.

FIG. 5B is a graph illustrating an example of a change in the number of jobs in a printer when the present exemplary embodiment is applied. In this example, the initial value of the transmission control value is set to 5, and jobs are transmitted accordingly. The printer enters the stand-by state in the first polling interval and in the second polling interval. However, the printer does not enter the stand-by state in third and subsequent polling intervals as the transmission control value is adjusted, as described in the present exemplary embodiment.

In the exemplary embodiment described above, the transmission control value is incremented or decremented by 1 in step S702 or S703. However, the value by which the transmission control value is incremented or decremented may be determined by calculating a difference between the threshold value and the number of jobs remaining in the printer. For example, when the threshold value is 3 and the number of jobs remaining in the printer is 0, the value by which the transmission control value is incremented is set to 3 such that the number of jobs remaining in the printer at a subsequent polling timing becomes 3 (the threshold value). In addition, when the threshold value is 3 and the number of jobs remaining in the printer is 7, the value by which the transmission control value is decremented is set to 4 such that the number of jobs remaining in the printer at a subsequent polling timing becomes 3 (the threshold value). In this manner, by determining the value by which the transmission control value is to be incremented or decremented through a calculation based on the number of jobs remaining in the printer, the time that it takes to eliminate the printer stand-by state can be reduced.

In the exemplary embodiment described above, in step S609, the transmission/reception unit 408 transmits jobs to the printer in a number obtained by subtracting the number of jobs remaining in the printer from the transmission control value. In addition, the transmission/reception unit 408 may also reduce the polling interval. Specifically, the polling interval in which the transmission/reception unit 408 polls the printer may be reduced successively by a predetermined unit of time (e.g., second). As the polling interval is reduced, the duration in which the printer is in the stand-by state can be reduced.

In the exemplary embodiment described above, the threshold value is set to a predetermined numerical value, but the threshold value may be defined by an upper limit value and a lower limit value. Specifically, when the number of jobs is within a range defined by the upper limit value and the lower limit value of the threshold value in step S605 of FIG. 6, the processing proceeds to step S609; whereas when the number of jobs falls outside the range defined by the upper limit value and the lower limit value of the threshold value, the processing proceeds to step S606. In addition, when the value by which the transmission control value is incremented or decremented is to be determined by calculating a difference between the threshold value and the number of jobs remaining in the printer, a value within the range defined by the upper limit value and the lower limit value of the threshold value may be used.

As described thus far, the printer stand-by state can be eliminated by incrementing or decrementing the transmission control value until the number of jobs in the printer falls to the threshold value at a polling timing.

A second exemplary embodiment will now be described. In the first exemplary embodiment, an example in which an initial value stored in the storage unit 406 is used as the initial value of the transmission control value has been described. In the present exemplary embodiment, instead of using the initial value stored in the storage unit 406, an initial value as a theoretical value is calculated when the theoretical value can be calculated, and the time that it takes to eliminate the printer stand-by state is reduced as a result.

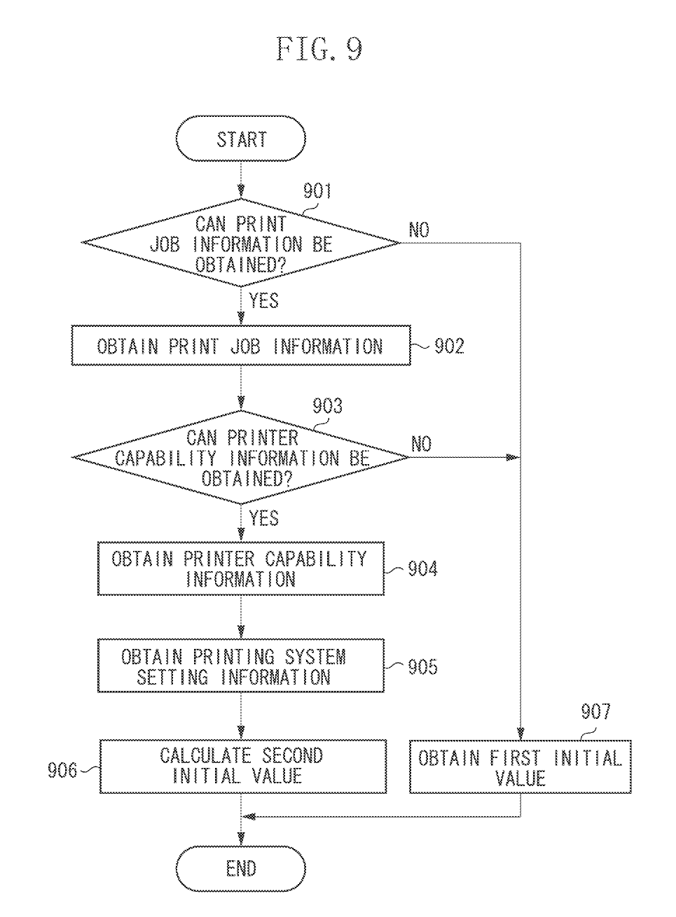

In the present exemplary embodiment, the process in step S601 of FIG. 6 is replaced by the processes illustrated in FIG. 9. Aside from replacing the process in step S601 of FIG. 6 by the processes illustrated in FIG. 9, the processing is similar to that of the first exemplary embodiment, and thus descriptions thereof will be omitted.

FIG. 9 is a flowchart for calculating an initial value of the transmission control value.

In step S901, the setting unit 403 determines whether it is possible to obtain print job information. For example, the setting unit 403 determines whether it is possible to obtain job information, such as an average number of pages contained in jobs to be subjected to printing thereafter. A production plan is often arranged in advance in a production site in which a due date is set, and the number of pages contained in a job is often determined in advance. In such a case, the print job information can be obtained. When it is possible to obtain the print job information in step S901 (YES in step S901), the processing proceeds to step S902. Meanwhile, when it is impossible to obtain the print job information (NO in step S901), the processing proceeds to step S907. In step S907, the setting unit 403 obtains an initial value (first initial value) of the transmission control value from the storage unit 406.

In step S902, the setting unit 403 obtains the print job information. Here, an example in which the average number of pages per job can be obtained will be described. Specifically, in a case in which information indicating that the average number of pages per job contained in the jobs to be subjected to printing is 25 is obtained, in step S902, the setting unit 403 obtains the print job information in which the average number of pages per job is set to 25. In step S903, the setting unit 403 determines whether it is possible to obtain the capability information of the printer (or determines whether a user sets the capability information of the printer). The capability information of the printer may be obtained from the printer or may be obtained through the user interface. When it is determined in step S903 that the capability information of the printer can be obtained (YES in step S903), the processing proceeds to step S904. In step S904, the setting unit 403 obtains the capability information of the printer. Examples of the capability information of the printer include the print engine speed and the number of sheets that can be fed. In this example in which the engine speed of the printer (typically, expressed in pages per minute (PPM)) is used, when the maximum engine speed of the target printer is 1500 ppm, the number of sheets that can be printed in 1 minute is 1500.

In step S905, the setting unit 403 obtains the setting information of the printing system. Examples of the setting information of the printing system include the polling intervals of the printing system.

In step S906, the setting unit 403 calculates the initial value (second initial value) of the transmission control value from the print job information, the capability information of the printer, and the setting information of the printing system, and sets the second initial value. The initial value calculated at this point is a theoretical number of jobs that can be processed in a polling interval and corresponds to a theoretical value obtained through calculation. The following expression is an example of a calculation method, and the number of pages that can be processed in a polling interval is calculated from the engine speed of the printer and the polling interval. Then, the initial value is calculated by dividing the number of pages that can be processed in the polling interval (the value calculated above) by the average number of pages per job.

The number of pages that can be processed in a polling interval=engine speed (PPM)/polling interval (2)

Initial value=the number of pages that can be processed in a polling interval/the average number of pages per job (3)

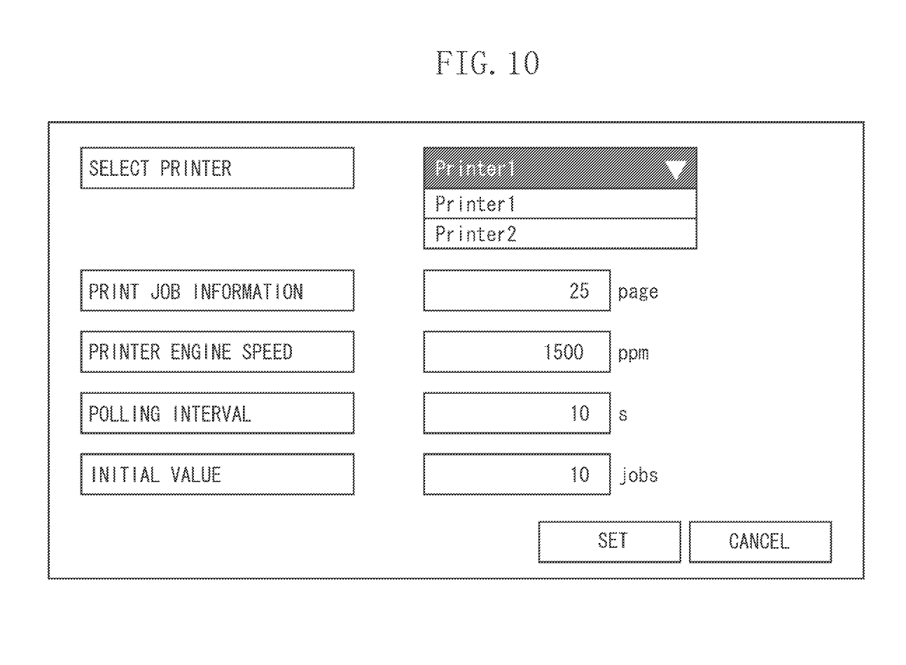

FIG. 10 illustrates an example of the user interface. The initial value (second initial value) is calculated automatically as the user selects a target printer, and the print job information, the printer engine speed information, and the polling interval are loaded from the printer and the system. When the SET button is pressed, the second initial value is applied. The values of the setting items on the user interface may not only be obtained automatically from the system or the printer but also be inputted by the user through the user interface.

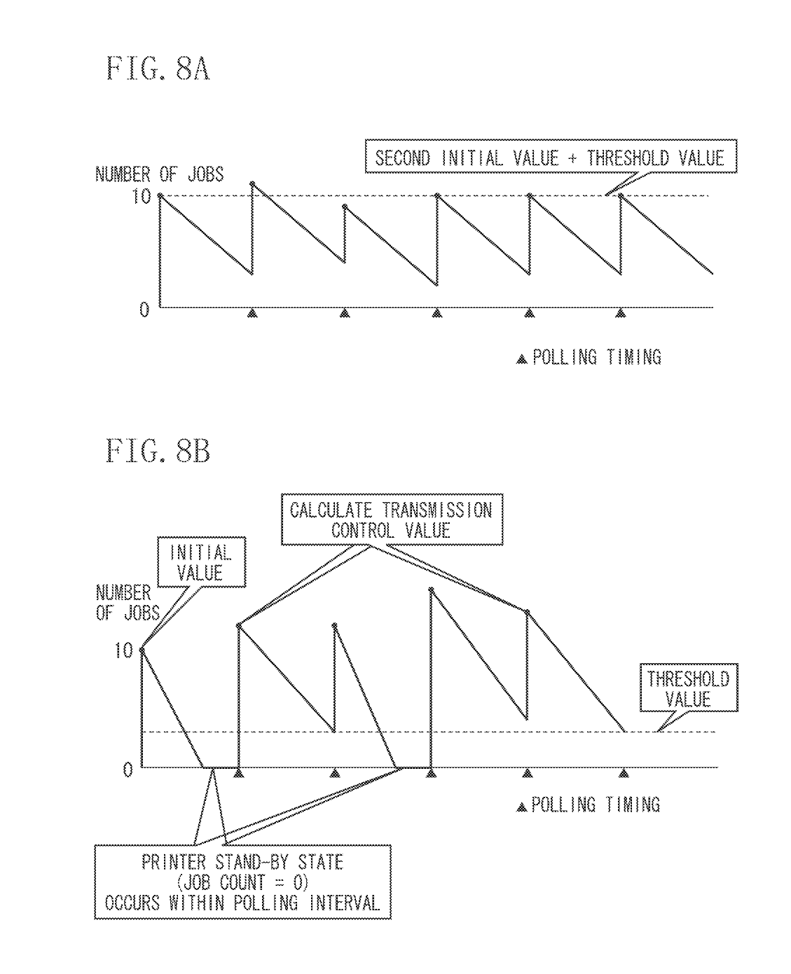

According to the present exemplary embodiment, by calculating the initial value, which is a theoretical value, and by using the calculated initial value, the time that it takes to eliminate the printer stand-by state can advantageously be reduced. FIG. 8A is a graph illustrating an example of a change in the number of jobs in the printer according to the present exemplary embodiment. In this example, the initial value, which is the theoretical value, is used, and thereby, the printer stand-by state does not occur.

According to the present exemplary embodiment, when the theoretical value can be calculated, the initial value, which is the theoretical value, is calculated, and the calculated initial value is used. However, the initial value, which is the theoretical value, may be calculated when any of the print job information, the capability information of the printer, and the setting information of the printing system has changed to a great extent.

A third exemplary embodiment will now be described. In the second exemplary embodiment, the time that it takes to eliminate the printer stand-by state has been reduced by using the theoretical value of the transmission control value as the initial value to be used for transmission control. In the third exemplary embodiment, the number of jobs that can be processed in a polling interval is calculated from job information (job completion time) notified by the printer, and the time that it takes to eliminate the printer stand-by state is reduced by using the calculated number of jobs as the transmission control value.

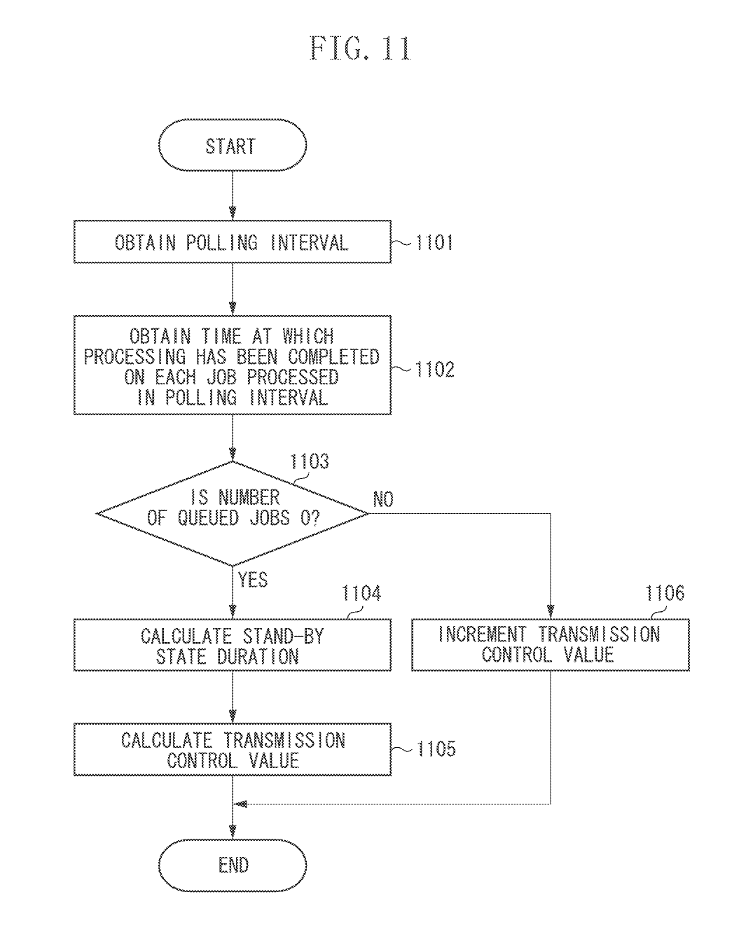

In the present exemplary embodiment, as a detailed flowchart of the process in step S601 of FIG. 6, the process is replaced by the processes illustrated in FIG. 11, instead of by the processes illustrated in FIG. 7. Aside from replacing the process in step S606 by the processes illustrated in FIG. 11, instead of by the processes illustrated in FIG. 7, the processing is similar to that of the first exemplary embodiment, and thus descriptions thereof will be omitted.

FIG. 11 is a detailed flowchart of step S606 according to the present exemplary embodiment.

In step S1101, the transmission control unit 405 obtains the polling interval for obtaining printer information from the printing system. In step S1102, the transmission control unit 405 obtains the time at which processing has been completed on each job processed in a polling interval. The transmission control unit 405 obtains the completion time information of each job from the printer information.

In step S1103, the transmission control unit 405 determines whether the number of jobs remaining in a job queue is 0. When it is determined in step S1103 that the number of jobs remaining in the job queue is 0 (YES in step S1103), the processing proceeds to step S1104. In step S1104, the transmission control unit 405 reads out at which timing in a polling interval a final job has been completed and subtracts the obtained time from the polling interval. The resulting time serves as the stand-by state duration of the printer.

In step S1105, the transmission control unit 405 calculates the transmission control value. An example of this calculation is indicated below. The polling interval is represented by PollingTime, the time at which a final job has been completed in the polling interval is represented by JobCompleteTime, and the stand-by state duration of the printer is represented by PrinterWaitTime. The stand-by state duration of the printer is expressed through Expression (4).

PrinterWaitTime=PollingTime−JobCompleteTime (4)

In addition, when the transmission control value is represented by MaxSendingJobCount, the transmission control value to be calculated is obtained through Expression (5).

NextMaxSendingJobCount=(PrinterWaitTime*MaxSendingJobCount)/JobCompleteTime+threshold value (5)

When the threshold value has a range, the upper limit value of the threshold value, for example, may be used.

When it is determined in step S1103 that the number of jobs remaining in the job queue is not 0 (NO in step S1103), the processing proceeds to step S1106. In step S1106, the transmission control value is incremented. The value by which the transmission control value is incremented may be 1, as in the first exemplary embodiment, or may be determined by using the number of jobs remaining in the printer.

According to the third exemplary embodiment, the number of jobs that can be processed in a polling interval is calculated from the job information (job completion time) notified by the printer, and the time that it takes to eliminate the printer stand-by state is advantageously reduced by using the calculated number of jobs as the transmission control value. FIG. 8B is a graph illustrating an example of a change in the number of jobs in the printer according to the present exemplary embodiment. In this example, since the printer stand-by state has occurred in the first polling interval, the transmission control value is calculated from the time at which the stand-by state has occurred, and the jobs are then transmitted in accordance with the calculated transmission control value. Thus, the printer stand-by state is eliminated in the subsequent polling interval.

As a modification of the present exemplary embodiment, the processes illustrated in FIG. 11 may be used when it is possible to obtain the job completion time from the printer, and the processes illustrated in FIG. 7 may be used when it is impossible to obtain the job completion time from the printer. Whether it is possible to obtain the job completion time from the printer may be determined by the setting unit 403 inquiring of the printer as to the device capability. For example, with a JDF-compatible device, the KnownMessages command (inquiry as to the capabilities that the printer supports) is issued, and it is determined whether the ReturnQueueEntry command (notification of the print result) is returned. Alternatively, the user may define the device capabilities in a configuration file, and the setting unit 403 may load the configuration file.

According to the exemplary embodiments described above, an effect that an occurrence of the printing stand-by state of the printer is reduced can be achieved.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-094792, filed May 1, 2014, which is hereby incorporated by reference herein in its entirety.

What is claimed is:

1. An information processing apparatus, comprising:
an obtaining unit configured to obtain a number of jobs in a printing apparatus at a timing that is associated with a timing at which the printing apparatus is polled;
a calculation unit configured to calculate a transmission control value associated with a number of jobs that are to remain in the printing apparatus, in a case in which the obtained number of jobs is not equal to a predetermined value; and
a transmission unit configured to transmit jobs according to a number of jobs determined from the calculated transmission control value, to the printing apparatus.

2. The information processing apparatus according to claim 1, wherein the calculation unit calculates the transmission control value from the obtained number of jobs.

3. The information processing apparatus according to claim 1, wherein the calculation unit calculates the transmission control value from a time at which the printing apparatus has finished processing jobs in a polling interval and a stand-by state duration of the printing apparatus.

4. A method for controlling an information processing apparatus, the method comprising:
obtaining, by an obtaining unit, a number of jobs in a printing apparatus at a timing that is associated with a timing at which the printing apparatus is polled;
calculating, by a calculation unit, a transmission control value associated with a number of jobs that are to remain in the printing apparatus, in a case in which the obtained number of jobs is not equal to a predetermined value; and
transmitting, by a transmission unit, jobs according to a number of jobs determined from the calculated transmission control value, to the printing apparatus.

5. The method for controlling an information processing apparatus according to claim 4, wherein, in the calculating, the transmission control value is calculated from the obtained number of jobs.

6. The method for controlling an information processing apparatus according to claim 4, wherein, in the calculating, the transmission control value is calculated from a time at which the printing apparatus has finished processing jobs in a polling interval and a stand-by state duration of the printing apparatus.

7. A computer-readable storage medium storing computer executable instructions that cause a computer to execute a method for controlling an information processing apparatus, the method comprising:
obtaining, by an obtaining unit, the a number of jobs in a printing apparatus at a timing that is associated with a timing at which the printing apparatus is polled;
calculating, by a calculation unit, a transmission control value associated with the a number of jobs that are to remain in the printing apparatus, in a case in which the obtained number of jobs is not equal to a predetermined value; and
transmitting, by a transmission unit, jobs in according to the a number of jobs determined from the calculated transmission control value, to the printing apparatus.
